(19) United States
(12) Patent Application Publication
(10) Pub. No.: US 2008/0289657 A1
(43) Pub. Date: Nov. 27, 2008

(54) Removing dust using a hand pump

(76) Inventor: Ray Arjomand, Sparks, NV (US)

Correspondence Address: RICHARD L HUFF, 19304 OLNEY MILL ROAD, OLNEY, MD, 20832, US

(21) Appl. No.: 12/218,828

(22) Filed: Jul. 21, 2008

Related U.S. Application Data
(63) Continuation-in-part of application No. 10/961,603, filed on Oct. 12, 2004, now abandoned.
(60) Provisional application No. 60/511,156, filed on Oct. 14, 2003.

(51) Int. Cl. B08B 5/00; B08B 5/04

(52) U.S. Cl. 134/21; 134/37

(57) ABSTRACT

A method of cleaning dust from a computer, computer keyboard, mouse, monitor, or desktop using a hand pump capable of blowing air out of the pump or vacuuming air into the pump. A pump for carrying out this method is disclosed, which pump contains a cylinder having a proximal end and a distal end, a piston inside the cylinder, a handle operatively attached to the proximal end of the piston, and a nozzle at the distal end of the cylinder wherein the hand pump contains side valves adjacent the distal end of the cylinder, which valves open when the piston is moved distally and a front valve which opens when the piston is moved proximally and the cylinder has a dust container surrounding the side valves to collect the dust exiting the side valves to prevent the dust from blowing outside of the cylinder.

### CROSS-REFERENCE TO RELATED APPLICATIONS

This application is a continuation-in-part of application Ser. No. 10/961,603 filed Oct. 12, 2004, which corresponds in subject matter to Disclosure Document No. 535537, entitled “Manual Air Pump For Removing Dust”, dated Jul. 28, 2003 and relies on the filing date of Oct. 14, 2003 for Provisional Application Ser. No. 60/511,156, all incorporated herein by reference.

### STATEMENT REGARDING FEDERALLY SPONSORED RESEARCH OR DEVELOPMENT

Not applicable

### REFERENCE TO SEQUENTIAL LISTING, A TABLE, OR A COMPUTER PROGRAM LISTING APPENDIX SUBMITTED ON A COMPACT DISC

Not applicable

### BACKGROUND OF THE INVENTION

1) Field of the Invention

The present invention generally relates to a method of using a manual air pump for removing dust. It is a method or process for removing dust or debris from computer parts using a manual hand air pump. The present invention is also directed to air pumps useful in carrying out the method of the invention.

2) Description of the Related Art

The manual air pump has not traditionally been thought of as a device for removing dust. The non-electric air pump is a mature technology. There are many different styles, makes, and models of manual air pumps, and there is no need to re-invent them in this application.

Every day, millions of condensed air cans (an aerosol-type device for removing dust) are sold on the internet and in office supply, computer, and hardware stores. Consumers use air cans to remove dust from computer, video, photographic and other sensitive equipment. At a cost of approximately $6 per can, it is an expensive item. Once used, these empty cans are thrown into landfills, wasting natural resources and damaging the environment.

U.S. Pat. No. 5,335,703 entitled “Rechargeable Dust-off Device And Method Of Using The Device” discloses a rechargeable air can. The device may be repetitively filled with compressed air using a valve which allows a bike pump or gas station pump to fill the device. Alternatively, a built-in pump connected to an inlet valve in the chamber may be implemented for introducing compressed air into the device. U.S. Pat. No. 4,874,404, entitled “Vacuum Cleaner,” features an Electric Vacuum Cleaner that uses water to filter out and remove dust. U.S. Pat. No. 5,531,722, entitled “Aspiration Unit,” applies to a device connected to an ultrasonic scaler that includes a novel suction device for carrying water and debris generated during scaling procedures away from a work site. U.S. Pat. No. 2,968,441, entitled “Spray Nozzle Assembly for Use with Aerosol Can,” covers a nozzle assembly and attachment that allows the user to spray directly and accurately on a location that is unavoidably separated from the can by various objects and structures. U.S. Pat. No. 5,989,360 entitled “Gas-Driven Portable Self-contained Vacuum Device,” features an attachment to a condensed air can that converts it into a vacuum device.

Electronic equipment such as computers, telephones, faxes, printers, and copiers gather dust over time. The dust creates a thermal blanket that damages sensitive equipment. Other devices such as computer keyboards, electric shavers, drapes, and telephones also gather dust and debris. Condensed air cans are presently used to remove the dust and dirt from the equipment by blowing it away.

Electrical vacuums either plug into wall outlets or are powered by batteries. Although electrical floor vacuums are very good for cleaning large rooms and rugs, they are not good for removing dust from sensitive electronic equipment. That is why millions of people buy air cans every day.

Some of the advantages of a hand pump over an electrical vacuum or pump are:

1. A hand pump requires no electrical wire or batteries.

2. A hand pump can provide a much stronger jolt of air than battery powered vacuum.

3. A hand pump is less expensive to manufacture because it has no electrical components.

4. An electrical floor vacuum is too bulky and powerful for sensitive equipment. It can damage the equipment by sucking the chips or loose screws.

5. Using the bulky floor vacuum is time-consuming and requires more energy.

For these reasons, millions of people buy air cans every day. Using the air can, however, has the following disadvantages:

1. It is expensive.

2. It runs out quickly.

3. Empty cans are thrown into landfills, creating pollution.

4. It wastes limited natural resources (aluminum and other raw materials).

5. It may explode if heated. It is flammable.

6. Often, it ejects cold liquid instead of dry air as it is supposed to do. This could damage sensitive equipment.

### BRIEF SUMMARY OF THE INVENTION

This invention is a method or process for removing dust or debris using a manual hand air pump. It is particularly useful for removing dust and debris from sensitive electronic equipment such as computers, computer keyboards, mice, and monitors. Presently condensed air cans are primarily used for removing dust from such equipment. A high-quality hand pump (approximately 1′ long and 3″ in diameter) may cost more than two condensed air cans, but it will last for many years. It is a user friendly device that requires no batteries or electricity. Since the user is not inflating anything (ball, bed, tire, etc.) and is only blowing air into space to remove dust, it requires very little energy to operate.

The hand pump generates a stronger jolt of air than is possible for any air can, and unlike the can, it never ejects cold liquid. Since it is re-usable, it is a lot cheaper than the air cans and does not pose waste disposal problems. The consumer saves money, gets a better product that lasts a lot longer and does not harm the environment.

Air pumps are used for blowing air into bicycle tires or inflatable boats, balls, beds and other inflatable objects. Since there are thousands of different shapes and forms of air pumps on the market, it is not feasible or necessary to include (re-invent) this old technology in this application.

The major difference between a bicycle-ball pump and the dust pump is in the nozzle. Generally bike-ball pumps have a standard size flat nozzle to fit any bicycle tire or ball. Typically the size of the bike-ball pump's nozzle opening or hole is approximately 0.095 inches and the nozzle is flat. However for dusting purposes the ideal size nozzle opening is approximately 0.08-0.12 inches and preferably the nozzle is cone shaped for better air flow. In addition, to prevent air from entering into the ball-bike pump's nozzle on the back stroke, the pump has a one-way valve inside its nozzle. Typically, a small steel ball in the nozzle acts as a check valve, blocking air from returning to the cylinder of the pump on the backstroke. Without the valve, the air pumped into the ball or tire will exit (escape) the ball or tire through the pump's nozzle on the backstroke.

A dust pump does not need to have such a valve inside its nozzle. Not having the valve reduces manufacturing cost and improves air flow out of the nozzle, resulting in a superior performance. To summarize, the differences between the nozzle of a bicycle or ball pump and dust pump are the following:

1. Unlike a bike-ball pump, the dust pump is valveless, that is, it does not have a valve inside its nozzle resulting in reduced manufacturing cost and better air flow out of the nozzle (superior performance).

2. To improve performance, the dust pump has a cone-shaped nozzle to increase air flow out of the nozzle with less manual force.

3. For dusting purposes, the ideal size opening for the nozzle is approximately 0.08-0.12 inches. The size of the nozzle opening (hole) has a significant impact on quantity and velocity of air out of the nozzle of the pump.

The hand pump can remove dust either by blowing it away or by sucking it into the pump (manual vacuum cleaner). The hand pump provides an inexpensive alternative to an air can. The hand pump has the following advantages over the air can:

1. Unlike the air can, a high quality hand pump can last many years.

2. Since it lasts a long time, it does not pollute the environment.

3. Although the price of a hand pump may initially be higher than the cost of a single air can, it is cheaper in the long run because it provides many years of service.

4. The user has control over the air pressure created by the hand pump.

5. A hand pump never ejects cold liquid into sensitive equipment like the air cans do.

6. Since the user is not inflating anything (ball, bed, tire, etc.) and is only blowing air into space to remove dust, the hand pump requires very little energy to operate, yet provides a much stronger jolt of air than the air can is capable of providing.

7. The pumping action provides a good hand exercise while cleaning.

8. In an alternative embodiment, a hand pump may be multi-functional. It may have a nozzle that can be replaced with another nozzle to inflate balls, tires, beds and other objects, like the Swiss army knife concept.

Below are drawings to demonstrate a hand pump used mainly for removing dust and debris. It should be understood that the description and drawings disclose specific embodiments and are for purposes of illustration only. There my be other modifications and changes obvious to those of ordinary skill in the art which fall within the scope of the present invention. For example the hand pump may have a different form or shape from illustrations below. Since there are hundreds of different shapes and models of manual pumps on the market today, one cannot incorporate all of them in this application-reinventing the wheel. With exceptions to be pointed out below, the shape or form of the manual hand pump is not the subject of this invention, but its use for removing dust and debris is.

### BRIEF DESCRIPTION OF THE SEVERAL VIEWS OF THE DRAWINGS

FIG. 1 is a vertical cross-sectional view of a first embodiment of a manual air pump having two handles and a stiff or flexible tube connected to the outlet port used for removing dust from computer parts by blowing and vacuuming.

FIG. 2 is a vertical cross-sectional view of a second embodiment of a manual air pump showing the piston moving down to force the air out the front outlet port to clean dust from computer parts by blowing.

FIG. 3 is a vertical cross-sectional view of a second embodiment of a manual air pump showing the piston moving up and filling the cylinder with air through the side inlet ports.

FIG. 4 is a vertical cross-sectional view of a third embodiment of a manual air pump with the piston moving up and filling the cylinder with air through the front inlet port to remove dust from computer parts by vacuuming.

FIG. 5 is a vertical cross-sectional view of a third embodiment of a manual air pump with a piston moving down to force dust-laden air out the side outlet ports.

FIG. 6 is a vertical cross-sectional view of a fourth embodiment of a manual vacuum pump having a dust container and anti-static wire attachment.

FIG. 7 is a side elevational view of a fifth embodiment of a manual pump, which is a flexible plastic hand pump suitable for use in this invention.

### DETAILED DESCRIPTION OF THE INVENTION

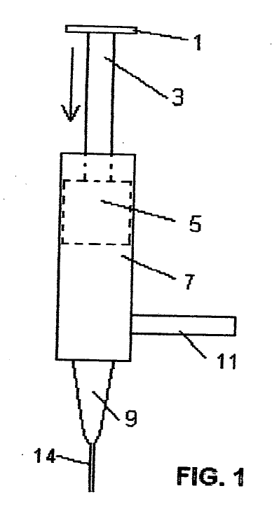

The first embodiment will be described with reference to FIG. 1. Directions of airflow throughout the following descriptions will be given in agreement with the directions shown in the drawings. In the following descriptions, “forward” refers to the direction which is toward the nozzle and “rearward” refers to the direction which is toward the handle. FIG. 1 is an example of a manual air pump for removing dust from computers and computer parts, such as keyboards, mice and monitors. The air pump has two handles 1, 11. The first handle 1 is attached to a bar 3 that is attached to a piston 5 which has a proximal end and a distal end. The piston 5 moves within the cylinder 7 which has a rearward (proximal) end and a forward (distal) end. The pump has preferably a non-flexible neck or nozzle 9 to direct the air flow. Preferably, the nozzle 9 is conical in shape to optimize the control over the air flow possessed by the operator. The outlet opening of the nozzle is 0.08 inches in diameter. The second handle 11 is optional and when present is securely attached to the body of the pump to facilitate holding the pump with one hand.

In operation, the user holds the pump with one hand using the second handle 11, and with the other hand presses the first handle 1 in the direction of the forward (distal) end of the cylinder 7. Thus, the use of the second handle 11 changes the manipulative steps relative to the method performed when the pump is used without the second handle 11. The use of the second handle 11 improves the method of this invention in that the pump may be steadier and the aim may be improved. The pressing of the first handle 1 forward forces the piston 5 to move forwardly within the cylinder 7 forcing the air out of the nozzle 9. The nozzle 9 can have a stiff or flexible tube 14 connected to it to allow the air output to be directed at the desired spot in places which are difficult to reach. The inlet/outlet port of the tube 14 may be 0.08-0.12 inch in diameter in order to optimize the speed of the air exiting the nozzle 9. The presence of a stiff or flexible tube 14 alters the manipulative steps of the method of this invention in that the forward end of the tube 14, not the nozzle 9 is held close to the area to be treated. In this description and claims, the term “close to” is intended to mean up to 2 inches from the target. The presence of a stiff or flexible tube 14 in the nozzle 9 improves the aim of the pump and allows the user to avoid bending over. The pump of FIG. 1 does not have any valves. This pump has the air inlet/outlet port at the forward end of the nozzle 9 and two small air inlet/outlet ports at the rear of the cylinder 7. The nozzles of the pumps of this invention are simply conical shaped tubes having an opening of 0.08-0.12 inch in diameter. The nozzles 9 have no valves in them. In this respect, if a nozzle 9 is described as consisting essentially of a conical wall 15, the term “consisting essentially of” is to be interpreted as excluding valves, which have a substantial effect on the operation of the pump.

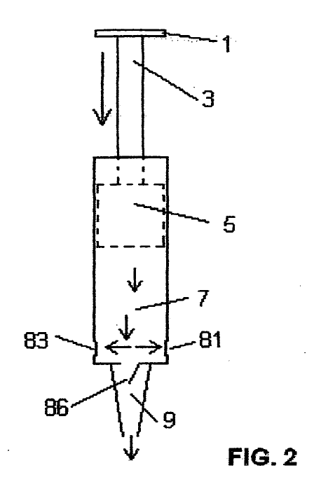

FIG. 2 shows a hand pump similar to that shown in FIG. 1, but with three valves 81, 83, 86 that open in only one direction. The side valves 81, 83 are located adjacent the forward end of the cylinder 7. The user pushes the handle 1 attached to bar 3 forwardly in the cylinder 7. As the piston 5 moves forwardly and forces the air forwardly in the direction shown, the rising air pressure inside the cylinder 7 forces the side valves 81, 83 to close and prevent the air from escaping from the sides of the cylinder 7. Simultaneously, the air pressure inside the cylinder 7 forces the front valve 86 open allowing air to escape out of the nozzle 9 in the direction indicated by the arrow. The addition of a stiff or flexible tubing 14 as in FIG. 1 to the nozzle 9 improves the aiming of the air.

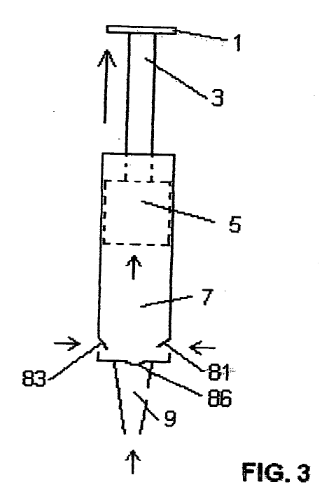

The pumps shown in FIGS. 1 and 2 are useful in creating air flow to blow dust and debris off of computers and computer parts, such as keyboards, monitors and mice, when the handle 1 is pushed forwardly. FIG. 3 shows what occurs in the pump of FIG. 2 when the handle is pulled rearwardly (proximally). The user pulls the handle 1 attached to the bar 3 rearwardly. As the piston 5 moves rearwardly (proximally) inside the cylinder 7, it creates a vacuum inside the cylinder 7. The outside pressure forces the side valves 81, 83 to open, letting air into the cylinder 7. Simultaneously, the outside pressure forces the front valve 86 to close, thereby preventing the dirty air from moving into the cylinder 7 from the nozzle 9 and the attached stiff tubing 14. Thus, the three valves 81, 83, 86 modify the manipulative steps of the method of this invention in allowing the nozzle 9 or forward end of the stiff tube 14 to be kept close to the computer parts while repeated strokes are made by the user in the blowing mode without dust being returned to the computer parts.

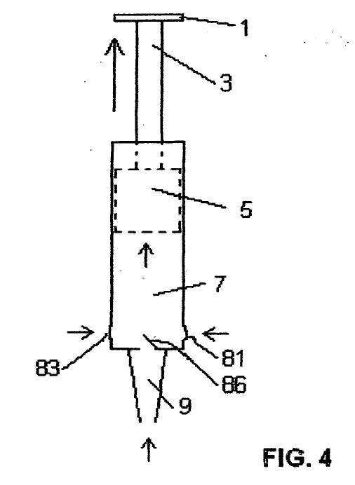

FIG. 4 is a third embodiment of a manual vacuum pump. This pump has three valves 81, 83, 86 that open in only one direction. When the user pulls the handle 1 attached to the bar 3 upwardly, the piston 5 moves up within the cylinder 7, creating a vacuum inside the cylinder 7. The outside air pressure forces the side valves 81, 83 to close, preventing outside air from entering the cylinder 7. Simultaneously, the outside air pressure forces the front valve 86 to open, thereby permitting the outside air to flow into the cylinder 7 from the nozzle 9 opening and any stiff tubing 14 attached thereto and the outside air pressure forces the dust and debris into the cylinder 7. Thus, the pump of the third embodiment cleans computer parts by vacuuming the dust and debris from the parts.

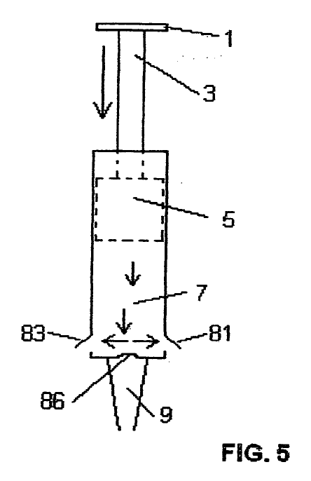

FIG. 5 shows what happens in response to a downward stroke in the pump of the third embodiment shown in FIG. 4. When the cylinder 7 is forced downward, the side valves 81, 83 open to permit the escape of air carrying dust and debris from inside the cylinder 7. Simultaneously, the high air pressure forces the forward valve 86 to close, preventing the air from escaping through the nozzle 9 opening. When the piston 3 is forced up by manual action, as in FIG. 4, dust and debris from the computer parts are sucked into the cylinder 7 and when the piston 5 is forced down, the dust and debris are forced out of the cylinder 7 at a location removed from the computer parts. This is especially true when a stiff tube 14 is attached to the nozzle 9. Thus, the three valves 81, 83, 86 affect the manipulative process in that they allow the nozzle 9 or stiff tube 14 to be held near the computer parts when the pump is used in a vacuuming mode and preventing dust from being returned to the computer parts.

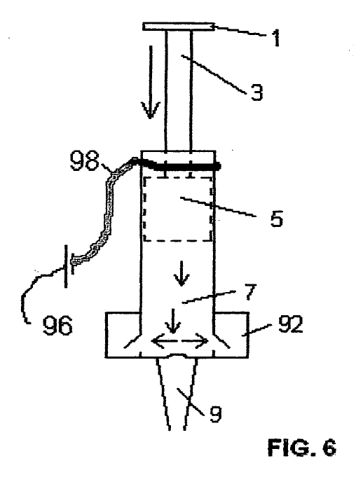

FIG. 6 illustrates a manual vacuum pump of a fourth embodiment. This pump is similar to that shown in FIG. 5 except that it has a dust container 92 surrounding the side valves 81, 83 to collect the dust and debris exiting the side valves 81, 83 to prevent the dust from blowing outside of the cylinder 7 into the room. The container 92 has a filter (not shown) that collects the dust while allowing the air to escape. This provides extra protection against dust which enters the pump from being returned to the computer parts. In addition, the pump of FIG. 6 has an optional anti-static conductive wire or band 98 attached to a local ground source 96. The anti-static wire 98 may be permanently attached to a metallic conductive part of the pump. The purpose of the anti-static wire 98 is to discharge any static electricity that may be present in the pump. Static electricity damages electronic equipment. The anti-static wire 98 prevents any damage to the computer equipment caused by static electricity. In this instance the pump is made from metallic substance that has a static discharge wire permanently attached to it to prevent and reduce the possibility of damage caused by static electricity. The manipulative steps using this device are expanded to include attaching the anti-static wire 98 to a ground.

In using one of the pumps illustrated in FIGS. 1-6, the user provides one of the pumps, holds the pump so that the nozzle 9 or opening of the stiff tube 14 is near the computer part to be treated, forces the handle 1 forwardly to expel air through the nozzle 9 or opening in the stiff tube 14 onto the computer or computer part when the pump is suitable for use as a blowing device, and pulls the handle 1 back in order to be able to repeat the process after the pump is moved to another area to be cleaned. When the pump is suitable for use as a vacuuming device, the user holds the pump near the computer part to be cleaned and pulls the handle 1 rearwardly to vacuum the dust from the computer part. The handle 1 is then forced forwardly to be ready to repeat the process.

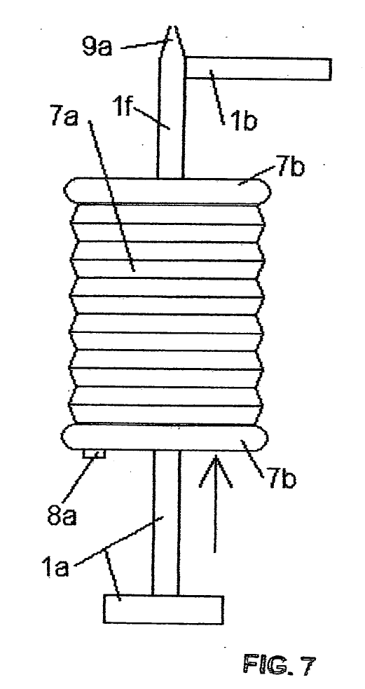

FIG. 7 shows a flexible plastic pump 100 to be used for removing dust. The pump 100 is made of plastic and has two non-flexible ends 7b that sandwich the flexible central part 7a. The central plastic section 7a expands and contracts by force of hand. The pump 100 has two end handles 1a, 1b. The forward handle 1b is attached to a neck portion if which is hollow to allow the air to pass through it. The neck portion if has a nozzle 9a at the forward end to direct the air flow.

The user holds the pump with the two handles 1a and 1b and squeezes the pump 100 manually. Since the pump 100 blows air into space to remove dust (not inflating anything) it requires very little energy. The air is forced out of the pump 100 through the nozzle 9a in the direction shown. Then the user pulls the two handles 1a, 1b apart to force air back into the pump 100 and expand the flexible central component 7a. Optionally, the pump may have an air-inlet valve 8a. The valve 8a allows the air into the pump 100 but not out of the pump 100. The pump 100 may also have a valve (not shown) in the neck portion if that allows air to exit the nozzle 9a but will prevent air from getting into the pump 100 through the nozzle 9a.

In performing the method of the present invention, the nozzle 9a of the pump 100 may be held close to the computer part and directed at the area to be cleaned. In one instance, where the pump 100 acts as a blower, the handle 1a is pushed forward to contract the pump and expel air to blow away the dust. In another instance, where the pump 100 acts as a vacuum pump, the handle 7b is pulled back to expand the pump and the dust enters the pump 100.

Although the invention has been described and illustrated in detail, it is to be clearly understood that the same is by way of illustration and example, and is not to be taken by way of limitation. The spirit and scope of the present invention are to be limited only by the terms of the appended claims.

I claim:

1. A method for removing dust from a computer, computer keyboard, mouse, or monitor comprising: providing a hand pump having a distal end and a proximal end, which pump has a cylinder and a nozzle at the distal end of the cylinder; holding the nozzle of the hand pump close to the computer, computer keyboard, mouse, or monitor; and operating the hand pump so as to create either a blowing of air out of the nozzle or a vacuuming of air into the nozzle.

2. The method of claim 1 wherein the hand pump contains an anti-static wire connecting the hand pump and computer equipment, thereby reducing damage to electronics from static electricity.

3. The method of claim 1 wherein the nozzle is conical in shape and has an outlet opening having a diameter of 0.08-0.12 inch.

4. The method of claim 1 in which the cylinder is made of plastic and is squeezed to contract the pump and force air from the nozzle or expanded to vacuum air into the cylinder.

5. The method of claim 4 wherein the pump is squeezed with hand pressure to blow dust from the computer, computer keyboard, mouse, or monitor.

6. The method of claim 4 wherein the pump is expanded to vacuum dust from the computer, computer keyboard, mouse, or monitor into the pump.

7. The method of claim 1 wherein the hand pump has a piston having a proximal end and a distal end inside the cylinder and a handle operatively attached to the proximal end of the piston.

8. The method of claim 7 wherein the hand pump has no valve inside the nozzle.

9. The method of claim 7 wherein the hand pump contains at least one valve.

10. The method of claim 7 wherein the handle is manipulated so as to blow air from the nozzle.

11. The method of claim 7 wherein the handle is manipulated so as to vacuum air into the nozzle.

12. The method of claim 10 wherein the hand pump contains side valves adjacent the distal end of the cylinder, which valves close when the piston is moved distally and open when the piston is moved proximally, and a front valve, which valve opens when the piston is moved distally and closes when the piston is moved proximally.

13. The method of claim 11 wherein the hand pump contains side valves adjacent the distal end of the cylinder, which valves close when the piston is moved proximally and open when the piston is moved distally, and a front valve, which valve opens when the piston is moved proximally and closes when the piston is moved distally.

14. The method of claim 13 wherein the cylinder has a dust container surrounding the side valves to collect the dust exiting the side valves to prevent the dust from blowing out of the cylinder.
